(19) United States
(12) Patent Application Publication
(10) Pub. No.: US 2022/0012589 A1
(43) Pub. Date: Jan. 13, 2022

(54) DATA CONVERSION DEVICE AND METHOD IN DEEP NEURAL CIRCUIT

(71) Applicant: Electronics and Telecommunications Research Institute, Daejeon (KR)

(72) Inventors: Jung Jae YU, Daejeon (KR); Jong Gook KO, Daejeon (KR); Won Young YOO, Daejeon (KR); Keun Dong LEE, Daejeon (KR); Su Woong LEE, Sejong-si (KR); Seung Jae LEE, Daejeon (KR); Yong Sik LEE, Busan (KR); Da Un JUNG, Gyeonggi-do (KR)

(73) Assignee: Electronics and Telecommunications Research Institute, Daejeon (KR)

(21) Appl. No.: 17/370,585

(22) Filed: Jul. 8, 2021

(30) Foreign Application Priority Data
Jul. 8, 2020 (KR) 10-2020-0084312
Jun. 25, 2021 (KR) 10-2021-0083336

(51) Int. Cl. G06N 3/08; G06N 3/063; G06K 9/62

(52) U.S. Cl. CPC G06N 3/08; G06N 3/063; G06K 9/6257; G06K 9/6232; G06K 9/6202

(57) ABSTRACT

A data learning device in a deep learning network characterized by a high image resolution and a thin channel at an input stage and an output stage and a low image resolution and a thick channel in an intermediate deep layer includes a feature information extraction unit configured to extract global feature information considering an association between all elements of data when generating an initial estimate in the deep layer; a direct channel-to-image conversion unit configured to generate expanded data having the same resolution as a final output from the generated initial estimate of the global feature information or intermediate outputs sequentially generated in subsequent layers; and a comparison and learning unit configured to calculate a difference between the expanded data generated by the direct channel-to-image conversion unit and a prepared ground truth value and update network parameters such that the difference is decreased.

### CROSS-REFERENCE TO RELATED APPLICATION

This application claims priority to and the benefit of Korean Patent Application No. 2020-0084312, filed on Jul. 8, 2020, and Korean Patent Application No. 2021-0083336, filed on Jun. 25, 2021, the disclosure of which is incorporated herein by reference in its entirety.

### BACKGROUND

### Field of the Invention

The present invention relates to a data conversion device in a deep neural circuit, and more particularly, to a data conversion device in a deep neural circuit that provides a data conversion method capable of performing global feature extraction considering a relationship between all elements of input data and extending an intermediate result with a long channel and a low resolution to a result with a single channel and a high resolution in a deep learning neural network with the UNet structure.

### 2. DISCUSSION OF RELATED ART

As shown in FIG. 1, a network referred to as the UNet structure refers to a symmetrical network structure with a short channel, a long spatial width, and a long spatial height in layers at an input stage 1 and an output stage 7 and a long channel, a long spatial width, and a long spatial height in deep layers 3, 4, and 5, which is the middle part of the network.

A simple method of learning such a network is a supervised learning method, which calculates (9) the difference between the result of the output stage 7 and a prepared ground truth value 8 and updates network parameters such that the difference is decreased.

The problem, in this case, is that it is easy for overfitting to occur because errors are calculated only at the final output stage.

A method used to compensate for these shortcomings is a method of generating an initial estimate 10 in a deep layer, comparing the initial estimate to a ground truth value 11 reduced to the same size, calculating an error 14, and performing learning.

In this way, the deep layer 4 is directly connected to a cost function, and learning efficiency in the deep layers 2 to 4 is improved.

One problem is that when calculating an error of an initial estimate at the intermediate position, the error is compared to a reduced ground truth value 11 rather than an original ground truth value 8. Thus, the error value may be relatively small.

Actually, when the initial estimate error 14 in the deep layer is added at the same rate as the error 9 at the final stage and optimization is performed, a result biased to a smoothed value is obtained for depth map estimation.

To solve this problem, a method of generating an expanded estimate 12 in the deep layer to the same size as the final output and calculating the original ground truth value 8 and the error 13 instead of the error of the reduced estimate 10 in the deep layer was provided, and it was announced that a method of using such an approach in the depth estimation field showed high performance.

### SUMMARY OF THE INVENTION

The present invention is directed to providing a method of extracting global feature information considering an association between all elements of input data in a deep learning neural network and a data conversion device in a deep neural circuit for generating expanded data having the same resolution as a final output in a deep layer having a lower resolution than the final output.

The present invention is not limited to the above objectives, but other objectives not described herein may be clearly understood by those skilled in the art from the descriptions below.

According to an aspect of the present invention, there is provided a data conversion device in a deep neural circuit, which is related to a data learning device in a deep learning network characterized by a high image resolution and a thin channel at an input stage and an output stage and a low image resolution and a thick channel in an intermediate deep layer, the data conversion device including a feature information extraction unit configured to extract global feature information considering an association between all elements of data received from a deep layer when generating an initial estimate in the corresponding layer, a direct channel-to-image conversion unit configured to generate expanded data having the same resolution as a final output using the generated initial estimate of the global feature information or intermediate outputs sequentially generated in subsequent layers; and a comparison and learning unit configured to calculate a difference between the expanded data generated by the direct channel-to-image conversion unit and a prepared ground truth value and update network parameters such that the difference is decreased.

The global feature information extraction unit may calculate elements in an output tensor by the non-linear weighted sum of all the elements of the input tensor.

The global feature information extraction unit may be configured to generate fully connected layers (FC layers) having a number of input/output nodes corresponding to lengths in a channel direction, a row direction, and a column direction of an input tensor received from the intermediate deep layer and cascade operations of applying the FC layers to output a result.

The operation process in the global feature information extraction unit will be sequentially described as follows. W*C column vectors of length H are extracted from the input tensor, and each of the column vectors passes through FCcol and replaces a corresponding existing value in the input tensor. Then, H*C row vectors of length W are extracted from the input tensors where all the existing values are replaced, and each of the row vectors passes through FCrow. Then, H*W channel vectors of length C are extracted, and each of the channel vectors passes through FCrow and replaces a corresponding existing value.

Also, the direct channel-to-image conversion unit may be configured to compress the input tensor to 2*k along a channel axis and configured to generate a horizontal conversion tensor by mapping k front-channel elements in an image-wise horizontal direction and then generate a vertical conversion tensor by k rear elements in an image-wise vertical direction along a single element axis in the horizontal and vertical directions. The direct channel-to-image conversion unit may generate a horizontal-conversion vertical-interpolation tensor by expanding the horizontal conversion tensor through linear interpolation in the vertical direction and generate a vertical-conversion horizontal-interpolation tensor by expanding the vertical conversion tensor through linear interpolation in the horizontal direction. The direct channel-to-image conversion unit may generate a tensor that is expanded k times in the horizontal and vertical directions by averaging the generated horizontal-conversion vertical-interpolation tensor and the generated vertical-conversion horizontal-interpolation tensor.

According to another aspect of the present invention, there is provided a data conversion method in a deep neural circuit, which is related to a method of extracting global feature information in a deep learning network characterized by a high image resolution and a thin channel at an input stage and an output stage and a low image resolution and a thick channel in an intermediate deep layer, the data conversion method including generating fully connected layers (FC layers) having a number of input/output nodes corresponding to lengths in a channel direction, a row direction, and a column direction from the intermediate deep layer, which is an input tensor; and cascading operations of applying the FC layers to output a result.

The data conversion method may further include generating expanded data having the same resolution as a final output using an initial estimate generated in the deep layer or intermediate outputs sequentially generated in subsequent layers.

The generating of expanded data may include compressing the input tensor to 2*k along a channel axis, generating a horizontal conversion tensor by mapping k front-channel elements in an image-wise horizontal direction, generating a vertical conversion tensor by mapping k rear elements in an image-wise vertical direction, generating a horizontal-conversion vertical-interpolation tensor by expanding the horizontal conversion tensor through linear interpolation in the vertical direction, generating a vertical-conversion horizontal-interpolation tensor by expanding the vertical conversion tensor through linear interpolation in the horizontal direction, and finally generating a tensor that is expanded k times in the horizontal and vertical directions by averaging the generated horizontal-conversion vertical-interpolation tensor and the generated vertical-conversion horizontal-interpolation tensor.

According to another aspect of the present invention, there is provided a direct channel-to-image conversion method in a deep learning network characterized by a high image resolution and a thin channel at an input stage and an output stage and a low image resolution and a thick channel in an intermediate deep layer, the direct channel-to-image conversion method including compressing an input tensor to 2*k along a channel axis, generating a horizontal conversion tensor by mapping k front-channel elements in an image-wise horizontal direction, generating a vertical conversion tensor by mapping k rear elements in an image-wise vertical direction, generating a horizontal-conversion vertical-interpolation tensor by expanding the horizontal conversion tensor through linear interpolation in the vertical direction, generating a vertical-conversion horizontal-interpolation tensor by expanding the vertical conversion tensor through linear interpolation in the horizontal direction, and finally generating a tensor that is expanded k times in the horizontal and vertical directions by performing an arithmetic operation on the generated horizontal-conversion vertical-interpolation tensor and the generated vertical-conversion horizontal-interpolation tensor.

### BRIEF DESCRIPTION OF THE DRAWINGS

FIG. 1 is a reference diagram illustrating a network structure of a typical UNet structure.

FIG. 2 is a block diagram illustrating a data conversion device in a deep neural circuit according to an embodiment of the present invention.

FIG. 3 is a conceptual diagram of a decomposed fully connected layer for extraction of a global feature from an input tensor according to an embodiment of the present invention.

FIG. 4 is a flowchart illustrating a method of actually implementing computation on a program according to an embodiment of the present invention.

FIG. 5 is a reference diagram illustrating a state of comparing expanded high-resolution data and a prepared ground truth value according to an embodiment of the present invention.

FIG. 6 is a reference diagram illustrating the concept of data expansion to be achieved through direct channel-to-image conversion according to an embodiment of the present invention.

FIG. 7 is a reference diagram illustrating a process of expanding data corresponding to one pixel on an image plane according to an embodiment of the present invention.

FIG. 8 is a conceptual view illustrating a data size change when direct channel-to-image conversion is applied to the entire input tensor according to an embodiment of the present invention.

FIG. 9 is a flowchart illustrating a data conversion method in a deep neural circuit according to an embodiment of the present invention.

### DETAILED DESCRIPTION OF EXEMPLARY EMBODIMENTS

Advantages and features of the present invention, and implementation methods thereof will be clarified through the following embodiments described in detail with reference to the accompanying drawings. However, the present invention is not limited to embodiments disclosed herein and may be implemented in various different forms. The embodiments are provided for making the disclosure of the prevention invention thorough and for fully conveying the scope of the present invention to those skilled in the art. It is to be noted that the scope of the present invention is defined by the claims. The terminology used herein is for the purpose of describing particular embodiments only and is not intended to be limiting of the invention. Herein, the singular shall be construed to include the plural, unless the context clearly indicates otherwise. The terms “comprises” and/or “comprising” as used herein specify the presence of stated elements, steps, operations, and/or components but do not preclude the presence or addition of one or more other elements, steps, operations, and/or components.

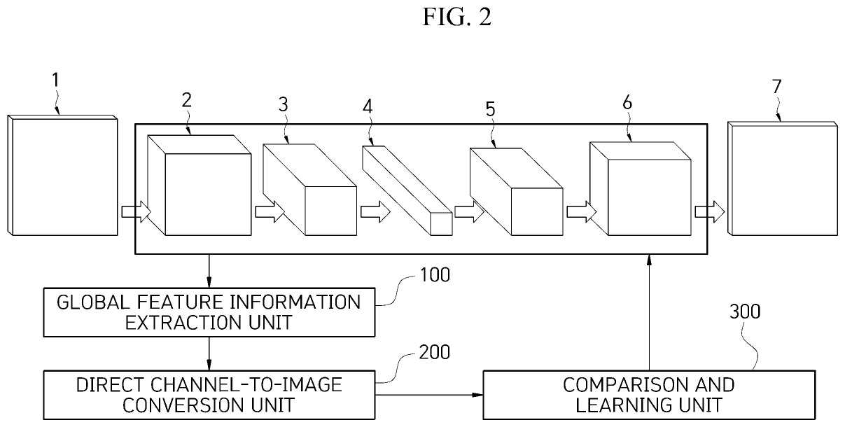

FIG. 2 is a block diagram illustrating a data conversion device in a deep neural circuit according to an embodiment of the present invention.

As shown in FIG. 2, the data conversion device in the deep neural circuit according to an embodiment of the present invention includes a global feature information extraction unit 100, a direct channel-to-image conversion unit 200, and a comparison and learning unit 300.

When generating an initial estimate in a deep layer over a deep learning network characterized by a high image resolution and a thin channel at an input stage 1 and an output stage 7 and a low image resolution and a thick channel for intermediate deep layers 2 to 6, the global feature information extraction unit 100 extracts global feature information considering the association between all elements of data received from the corresponding layer.

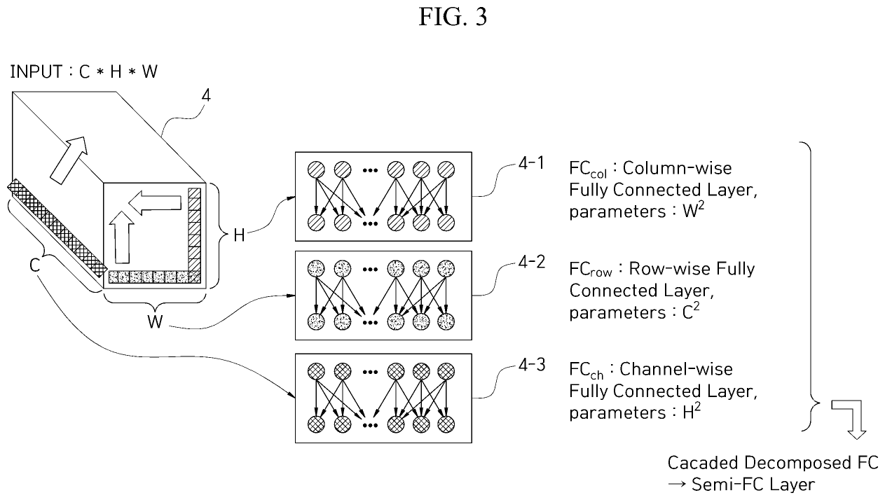

To this end, when an input tensor is an intermediate deep layer 4, the global feature information extraction unit 100 generates fully connected layers (FC layers) 4-1, 4-2, and 4-3, each of which has input/output nodes corresponding to lengths in the directions of a channel, a row, and a column of the input tensor received from the intermediate deep layer 4, as shown in FIG. 3.

Subsequently, the global feature information extraction unit 100 calculates an output tensor having the same size (C*H*W) as the input tensor by cascading operations of applying the FC layers. At this time, elements in the output tensor are calculated by using the non-linear weighted sum of all the elements of the input tensor.

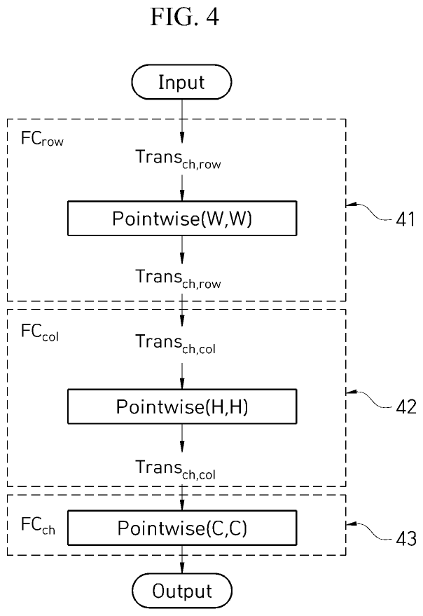

For example, it is assumed that a tensor having a size of C*H*W (C: channel length, H: number of rows, W: number of columns) is input as shown in FIG. 4.

First, W*C column vectors of length H are extracted from the input tensor, and each of the column vectors passes through FCcol and replaces a corresponding existing value in the input tensor (41).

Then, H*C row vectors of length W are extracted from the tensor in which all values have been replaced in this way, and each of the row vectors passes through FCrow and replaces a corresponding existing value (42).

Last, H*W channel vectors of length C are extracted, and each of the channel vectors passes through FCrow and replaces a corresponding existing value (43).

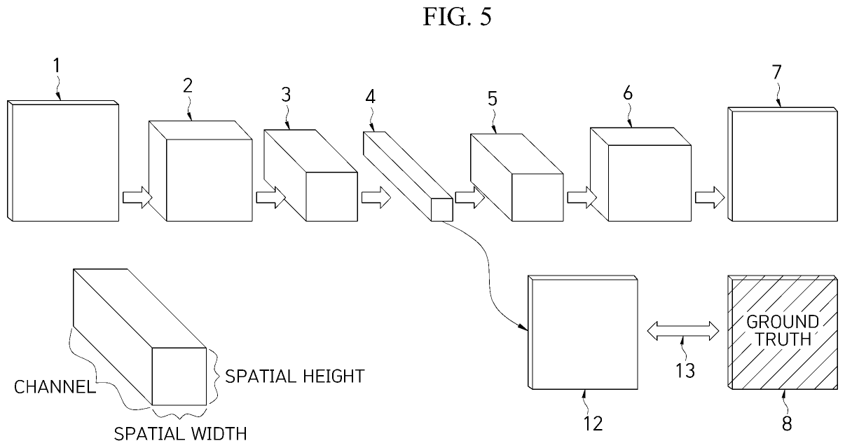

In addition, as shown in FIG. 5, the direct channel-to-image conversion unit 200 generates expanded data 12 of a high resolution, which is the same as that of the final output, using the generated initial estimate of the global feature information or intermediate outputs sequentially generated in subsequent layers.

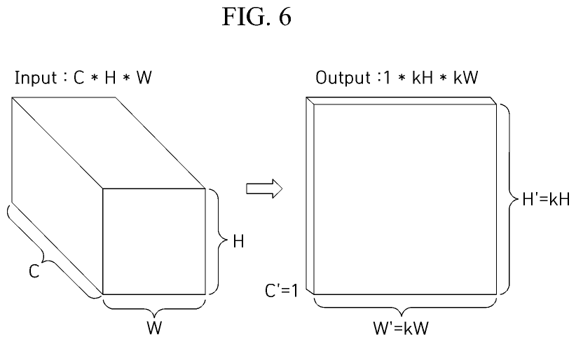

To this end, as shown in FIG. 6, it is assumed that the direct channel-to-image conversion unit 200 should generate signal channel data 12 expanded k times in horizontal and vertical directions using the tensor of C*H*W as an input.

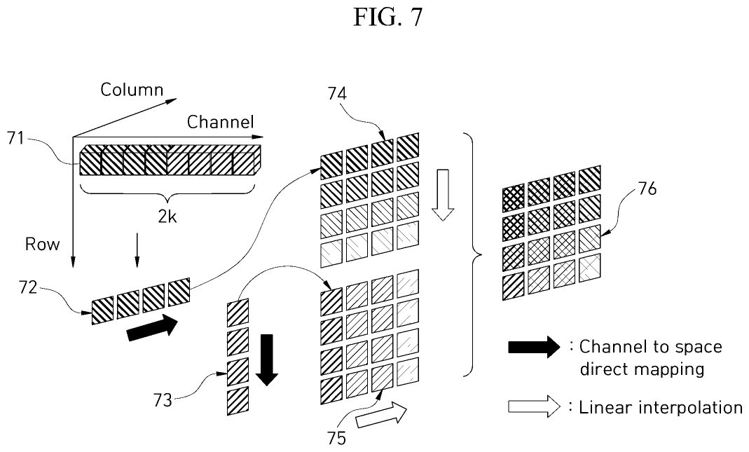

FIG. 7 is a reference diagram illustrating a process of expanding data corresponding to one pixel on an image plane according to an embodiment of the present invention.

As shown in FIG. 7, first, the direct channel-to-image conversion unit 200 compresses an input tensor to 2*k along a channel axis (71). Here, first, the input tensor refers to three-dimensional (3D) data 71 having three axes of a channel, a row, and a column so as to extract global feature information from any layer of a deep learning network.

Also, the direct channel-to-image conversion unit 200 generates a horizontal conversion tensor 72 by mapping in an image-wise horizontal direction using k front-channel elements along a single element axis in the horizontal and vertical directions.

The direct channel-to-image conversion unit 200 generates a vertical conversion tensor 73 by mapping in an image-wise vertical direction using k rear elements.

Subsequently, the direct channel-to-image conversion unit 200 generates a horizontal-conversion vertical-interpolation tensor 74 by expanding the horizontal conversion tensor 72 through linear interpolation in the vertical direction and generates a vertical-conversion horizontal-interpolation tensor 75 by expanding the vertical conversion tensor 73 through linear interpolation in the horizontal direction.

The direct channel-to-image conversion unit 200 finally generates a tensor 76 that is expanded k times in the horizontal and vertical directions by performing an arithmetic operation on the generated horizontal-conversion vertical-interpolation tensor 74 and the generated vertical-conversion horizontal-interpolation tensor 75. In this embodiment, the direct channel-to-image conversion unit 200 averages the generated horizontal-conversion vertical-interpolation tensor 74 and the generated vertical-conversion horizontal-interpolation tensor 75, but instead may add the generated horizontal-conversion vertical-interpolation tensor 74 and the generated vertical-conversion horizontal-interpolation tensor 75.

The comparison and learning unit 300 calculates a difference between the expanded tensor 76 generated by the direct channel-to-image conversion unit and a prepared ground truth value and updates network parameters such that the difference is decreased.

According to an embodiment of the present invention, by enabling pixel-wise non-linear expansion in image-wise horizontal and vertical axis directions, it is possible to solve overfitting, which is a problem of a supervised learning method that calculates a difference between a prepared ground truth value and a result of an output stage and updates network parameters such that the difference is decreased, and also improve learning efficiency in a deep learning neural network of the UNet structure.

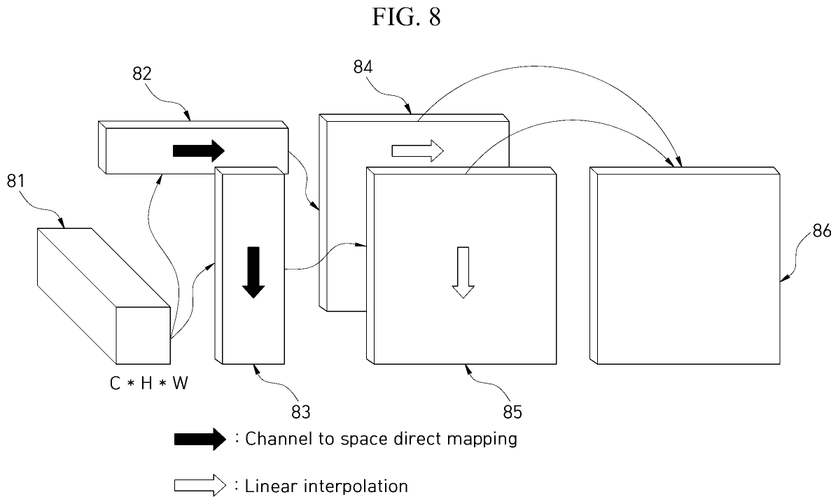

A data conversion method in a deep neural circuit according to an embodiment of the present invention will be described below with reference to FIG. 8.

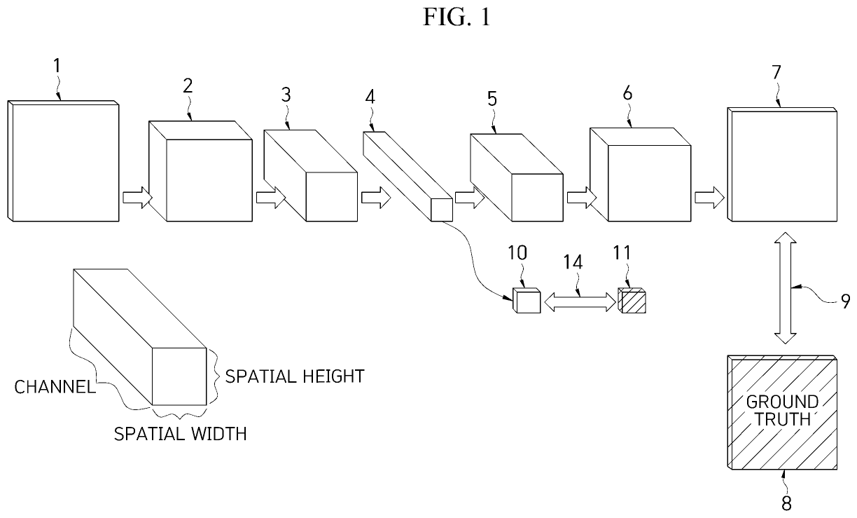

First, as shown in FIG. 1, the present invention is applied to a deep learning network (UNet structure) that is characterized by a high image resolution and a thin channel at an input stage 1 and an output stage 7 and a low image resolution and a thick channel at intermediate deep layers 2 to 6.

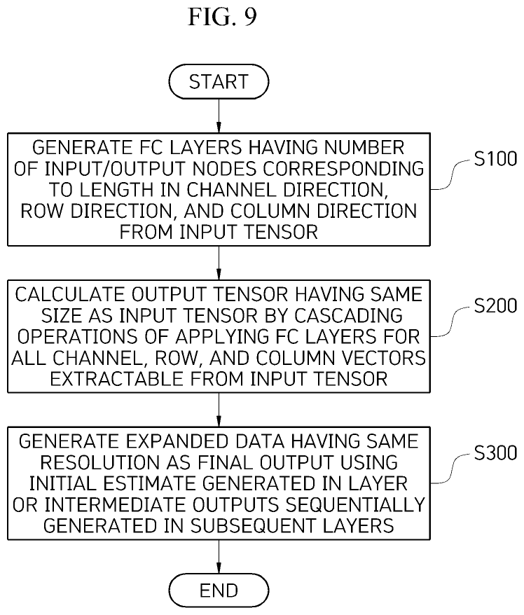

FIG. 9 is a flowchart illustrating a data conversion method in a deep neural circuit according to an embodiment of the present invention.

The data conversion method in a deep neural circuit according to an embodiment of the present invention will be described below with reference to FIG. 9.

First, FC layers having a number of input/output nodes corresponding to lengths in a channel direction, a row direction, and a column direction are generated from an input tensor (S100).

By cascading operations of applying the FC layers, a result is output (S200).

Expanded data having the same resolution as a final output is generated using an intermediate output, which is an initial estimate generated in the deep layer (S300). Here, intermediate outputs sequentially generated in subsequent deep layers may be used to generate the expanded data of the same resolution as that of the final output.

The operation of generating FC layers (S100) and the operation of calculating the tensor (S200) are for extracting global feature information in consideration of an association between all elements of data received from the deep layer when generating the initial estimate in the corresponding layer.

To extract global feature information, a decomposed fully connected layer (DFC layer) is used.

First, it is assumed that 3D data 21 having three axes of a channel, a row, and a column is input to extract global feature information from any layer of a deep learning network. At this time, the 3D data is referred to as a tensor.

FIG. 3 is a conceptual diagram of a decomposed fully connected layer for extraction of a global feature from an input tensor according to an embodiment of the present invention.

As shown in FIG. 3, FC layers 4-1, 4-2, and 4-3, which have input/output nodes corresponding to lengths in the directions of a channel, a row, and a column, are generated from an input tensor 4.

By cascading operations of applying the FC layers, a result is output.

For example, it is assumed that a tensor having a size of C*H*W (C: channel length, H: number of rows, W: number of columns) is input.

First, W*C column vectors of length H are extracted from the input tensor 4, and each of the column vectors passes through FCcol and then replaces a corresponding existing value in the input tensor (41).

Then, H*C row vectors of length W are extracted from the tensor in which all values have been replaced in this way, and each of the row vectors passes through FCrow and replaces a corresponding existing value (42).

Last, H*W channel vectors of length C are extracted, and each of the channel vectors passes through FCrow and replaces a corresponding existing value (43).

FIG. 4 is a flowchart illustrating a method of actually implementing computation on a program according to an embodiment of the present invention.

As shown in FIG. 4, FCrow(41), FCcol(42), FCch(43) are methods that actually implement the FC layers 4-1, 4-2, and 4-3 shown in FIG. 3, respectively.

As shown, FCch(43) is implemented as a single pixel convolution operation (1*1 convolution), and FCcol(42) and FCch(43) include Transpose operations (Transch,row and Transch,col) and Pointwise convolution.

In this case, a Transpose operation refers to an operation of replacing two axial directions of an input tensor.

When the method according to an embodiment of the present invention is actually utilized, an additional channel division and a 2D convolution operation may be used together according to the characteristics of the entire network that utilizes this operation.

In order to compare initial estimate data generated by extracting global features from the deep layer in the above way to a ground truth value 8 having the same size as the final output like 13 of FIG. 1, there is a need for a process of expanding the estimate data to the same size as the final output.

To this end, a direct channel-to-image conversion method (direct channel-to-space transformation) in a deep neural circuit according to an embodiment of the present invention is further included.

That is, the direct channel-to-image conversion method of the data conversion device in a deep neural circuit according to an embodiment of the present invention is a method of generating expanded data 12 having the same resolution as the final output 8 using a generated initial estimate or intermediate outputs sequentially generated in subsequent layers, as shown in FIG. 5.

FIG. 6 is a reference diagram illustrating the concept of data expansion to be achieved through direct channel-to-image conversion according to an embodiment of the present invention.

First, as shown in FIG. 6, it is assumed that signal channel data (12 in FIG. 1) expanded k times in horizontal and vertical directions should be generated using a tensor of C*H*W as an input.

FIG. 7 is a reference diagram illustrating a process of expanding data corresponding to one pixel on an image plane according to an embodiment of the present invention.

As shown in FIG. 7, first, an input tensor is compressed to 2*k along a channel axis (71).

Also, a horizontal conversion tensor 72 expanded in an image-wise horizontal direction is generated from k front-channel elements along a single element axis in the horizontal and vertical directions.

A vertical conversion tensor 73 expanded in an image-wise vertical direction is generated from k rear elements.

A horizontal-conversion vertical-interpolation tensor 74 is generated by expanding the horizontal conversion tensor 72 through linear interpolation in the vertical direction, and a vertical-conversion horizontal-interpolation tensor 75 is generated by expanding the vertical conversion tensor 73 through linear interpolation in the horizontal direction.

A tensor 76 that is expanded k times in the horizontal and vertical directions is generated by averaging the generated horizontal-conversion vertical-interpolation tensor 74 and the generated vertical-conversion horizontal-interpolation tensor 75.

FIG. 8 is a conceptual view illustrating a data size change when direct channel-to-image conversion is applied to the entire input tensor according to an embodiment of the present invention.

FIG. 8 is a reference diagram illustrating a data size change when direct channel-to-image conversion is applied to the entire input tensor according to an embodiment of the present invention.

As shown in FIG. 8, reference numerals 71 to 76, which are step-by-step results of the conversion method applied in units of one pixel in FIG. 7, may correspond to reference numerals 81 to 86, which are step-by-step results when the conversion method is applied to the entire tensor data.

According to an embodiment of the present invention, it is possible to extract global feature information calculated according to a correlation between all elements in an input tensor of a deep learning network. Also, when direct channel-to-image conversion is used, an input tensor with a low image resolution and a long channel axis may be converted into expanded data with a single channel and a high image resolution. In this case, it is possible to enable pixel-wise non-linear expansion in image-wise horizontal and vertical axial directions.

According to an embodiment of the present invention, by enabling pixel-wise non-linear expansion in image-wise horizontal and vertical axial directions, it is possible to solve overfitting, which is a problem of a supervised learning method that calculates a difference between a prepared ground truth value and a result of an output stage and updates network parameters such that the difference is decreased, and also improve learning efficiency in a deep learning neural network of the UNet structure.

Each step included in the learning method described above may be implemented as a software module, a hardware module, or a combination thereof, which is executed by a computing device.

Also, an element for performing each step may be respectively implemented as first to two operational logics of a processor.

The software module may be provided in RAM, flash memory, ROM, erasable programmable read only memory (EPROM), electrical erasable programmable read only memory (EEPROM), a register, a hard disk, an attachable/detachable disk, or a storage medium (i.e., a memory and/or a storage) such as CD-ROM.

An exemplary storage medium may be coupled to the processor, and the processor may read out information from the storage medium and may write information in the storage medium. In other embodiments, the storage medium may be provided as one body with the processor.

The processor and the storage medium may be provided in application specific integrated circuit (ASIC). The ASIC may be provided in a user terminal. In other embodiments, the processor and the storage medium may be provided as individual components in a user terminal.

Exemplary methods according to embodiments may be expressed as a series of operation for clarity of description, but such a step does not limit a sequence in which operations are performed. Depending on the case, steps may be performed simultaneously or in different sequences.

In order to implement a method according to embodiments, a disclosed step may additionally include another step, include steps other than some steps, or include another additional step other than some steps.

Various embodiments of the present disclosure do not list all available combinations but are for describing a representative aspect of the present disclosure, and descriptions of various embodiments may be applied independently or may be applied through a combination of two or more.

Moreover, various embodiments of the present disclosure may be implemented with hardware, firmware, software, or a combination thereof. In a case where various embodiments of the present disclosure are implemented with hardware, various embodiments of the present disclosure may be implemented with one or more application specific integrated circuits (ASICs), digital signal processors (DSPs), digital signal processing devices (DSPDs), programmable logic devices (PLDs), field programmable gate arrays (FPGAs), general processors, controllers, microcontrollers, or microprocessors.

The scope of the present disclosure may include software or machine-executable instructions (for example, an operation system (OS), applications, firmware, programs, etc.), which enable operations of a method according to various embodiments to be executed in a device or a computer, and a non-transitory computer-readable medium capable of being executed in a device or a computer each storing the software or the instructions.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

In the above, the configuration of the present invention has been described in detail with reference to the accompanying drawings, but this is merely an example. It will be appreciated that those skilled in the art can make various modifications and changes within the scope of the technical spirit of the present invention. Therefore, the scope of the present invention should not be limited to the above-described embodiments and should be defined by the appended claims.

What is claimed is:

1. A data conversion device in a deep neural circuit, which is related to a data learning device in a deep learning network characterized by a high image resolution and a thin channel at an input stage and an output stage and a low image resolution and a thick channel in an intermediate deep layer, the data conversion device comprising:
a feature information extraction unit configured to extract global feature information considering an association between all elements of data received from a deep layer when generating an initial estimate in the corresponding layer;
a direct channel-to-image conversion unit configured to generate expanded data having the same resolution as a final output using the generated initial estimate of the global feature information or intermediate outputs sequentially generated in subsequent layers; and
a comparison and learning unit configured to calculate a difference between the expanded data generated by the direct channel-to-image conversion unit and a prepared ground truth value and update network parameters such that the difference is decreased.

2. The data conversion device of claim 1, wherein the global feature information extraction unit is configured to:
generate fully connected layers (FC layers) having a number of input/output nodes corresponding to lengths in a channel direction, a row direction, and a column direction from the intermediate deep layer, which is an input tensor; and
cascade operations of applying the FC layers to output a result.

3. The data conversion device of claim 1, wherein the direct channel-to-image conversion unit is configured to:
compress the input tensor to 2*k along a channel axis;
generate a horizontal conversion tensor by mapping k front-channel elements in an image-wise horizontal direction and then generate a vertical conversion tensor by mapping k rear elements in an image-wise vertical direction;
generate a horizontal-conversion vertical-interpolation tensor by expanding the horizontal conversion tensor through linear interpolation in the vertical direction and generate a vertical-conversion horizontal-interpolation tensor by expanding the vertical conversion tensor through linear interpolation in the horizontal direction; and
finally generate a tensor that is expanded k times in the horizontal and vertical directions by averaging the generated horizontal-conversion vertical-interpolation tensor and the generated vertical-conversion horizontal-interpolation tensor.

4. A data conversion method in a deep neural circuit, which is related to a method of extracting global feature information in a deep learning network characterized by a high image resolution and a thin channel at an input stage and an output stage and a low image resolution and a thick channel in an intermediate deep layer, the data conversion method comprising:
generating fully connected layers (FC layers) having a number of input/output nodes corresponding to lengths in a channel direction, a row direction, and a column direction from the intermediate deep layer, which is an input tensor; and
cascading operations of applying the FC layers to output a result.

5. The data conversion method of claim 4, generating expanded data having the same resolution as a final output using an initial estimate generated in the deep layer or intermediate outputs sequentially generated in subsequent layers.

6. The data conversion method of claim 5, wherein the generating of expanded data comprises:
compressing the input tensor to 2*k along a channel axis;
generating a horizontal conversion tensor by mapping k front-channel elements in an image-wise horizontal direction;
generating a vertical conversion tensor by mapping k rear elements in an image-wise vertical direction;
generating a horizontal-conversion vertical-interpolation tensor by expanding the horizontal conversion tensor through linear interpolation in the vertical direction;
generating a vertical-conversion horizontal-interpolation tensor by expanding the vertical conversion tensor through linear interpolation in the horizontal direction; and
finally generating a tensor that is expanded k times in the horizontal and vertical directions by averaging the generated horizontal-conversion vertical-interpolation tensor and the generated vertical-conversion horizontal-interpolation tensor.

7. A direct channel-to-image conversion method in a deep learning network characterized by a high image resolution and a thin channel at an input stage and an output stage and a low image resolution and a thick channel in an intermediate deep layer, the direct channel-to-image conversion method comprising:
compressing an input tensor to 2*k along a channel axis;
generating a horizontal conversion tensor by mapping k front-channel elements in an image-wise horizontal direction; generating a vertical conversion tensor by mapping k rear elements in an image-wise vertical direction;
generating a horizontal-conversion vertical-interpolation tensor by expanding the horizontal conversion tensor through linear interpolation in the vertical direction;
generating a vertical-conversion horizontal-interpolation tensor by expanding the vertical conversion tensor through linear interpolation in the horizontal direction; and
finally generating a tensor that is expanded k times in the horizontal and vertical directions by averaging the generated horizontal-conversion vertical-interpolation tensor and the generated vertical-conversion horizontal-interpolation tensor.
